(19) United States
(12) Patent Application Publication
(10) Pub. No.: US 2009/0049099 A1
(43) Pub. Date: Feb. 19, 2009

(54) METHOD AND APPARATUS FOR MANAGING MEDIA FILE

(75) Inventors: Kyung-sun CHO, Seoul (KR); Jeong-hoon Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/166,497

(22) Filed: Jul. 2, 2008

(30) Foreign Application Priority Data
Aug. 14, 2007 (KR) 10-2007-0081713

(51) Int. Cl. G06F 17/30; G06F 15/16

(52) U.S. Cl. 707/104.1; 709/201; 707/E17.044

(57) ABSTRACT

A method and apparatus for managing a media file are provided. The method of managing a media file comprising a plurality of media objects comprises correcting at least one media object from among the plurality of the media objects; generating or renewing information relating to unused regions generated in the media file according to the correction; and managing the media file based on the generated or renewed information. Therefore, difficulties in file management occurring due to correction of the media objects are reduced so that the media file can be efficiently managed.

### CROSS-REFERENCE TO RELATED PATENT APPLICATION

This application claims priority from Korean Patent Application No. 10-2007-0081713, filed on Aug. 14, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to managing a media file, and more particularly, to managing a media file more efficiently by controlling difficulties in file management occurring due to correction of media objects included in the media file.

2. Description of the Related Art

In line with the development of wired or wireless networks, the production and use of multimedia content such as audio and video files have increased considerably. In particular, since User Created Content (UCC) are publicly available, many users can produce and edit various content. Users, who have simply used multimedia content provided by a specific content provider, also participate in producing and editing content so that correction of a media file including multimedia content is frequently performed by using various methods. However, correction of the media file causes a new overhead in media file management. This will be described in more detail with reference to FIG. 1.

FIG. 1 illustrates a related art media file.

FIG. 1 illustrates an International Standards Organization (ISO) based media file format. Referring to FIG. 1, the media file 100 includes a file header region 110, a meta data region 120, and a media data region 130.

The file header region 110 includes basic information of the content included in the media file 100. For example, information such as a content identifier, a content producer, and a producing time may be included in the file header region 110. When the media file 100 is divided into a plurality of tracks 121 through 123 or streams, map configuration information can be included in the file header region 110.

The meta data region 120 includes separate information of a plurality of media objects included in the media file 100. Various profile information and location information of the media objects are included in the meta data region 120 in order to decode the media objects. The media object is a minimum unit of content and one image frame which is displayed on a screen in every unit of time may be a media object. In case of audio, one audio frame which is reproduced in every unit of time may be a media object.

A plurality of media objects can exist in each track, and information needed to reproduce such media objects is included in the meta data region 120. Also, information relating to a time and offset of the media objects may be included in the meta data region 120. Offset information indicates where the media data for the media objects exists in the media data region 130.

In FIG. 1, it is assumed that a media object 124 in a first unit of time, a media object 125 in a second unit of time, and a media object 126 in a third unit of time are media object 1, media object 2, and media object 3, respectively.

Media data of the media object 1 is stored in offset from “0x00” to “0x04”, media data of the media object 2 is stored in offset from “0x05” to “0x11”, and media data of the media object 3 is stored in offset from “0x12” to “0x16”.

When a user of the media file corrects the media file so as to delete media object 2, 125, data from offset “0x04” to “0x11” is deleted. According to the deletion of the media object, information relating to the media object 2, 125 in the meta data region 120 and the media data region 130 is completely deleted.

Accordingly, a region for storing media data from offset “0x00” to “0x04” in the media file becomes an unused region where media data is not stored.

In order to move media data of the media object 3, 126 so as to remove the unused region, the media object 3, 126 and meta data relating to locations of all media objects should be corrected. Such process causes a great load on a system for managing the media file. In particular, when the media file is managed in devices where hardware resources are not sufficient, such as a portable terminal, the performance of the system is greatly affected.

When the unused region is left as it is, in order to prevent the performance of the system from being affected, a size of the media file is not reduced so that use of the memory is inefficient, regardless of the deletion of the media objects.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for efficiently managing a media file by overcoming difficulties in file management occurring due to the correction of media objects included in the media file, and a computer readable recording medium having embodied thereon a computer program for executing the method.

According to an aspect of the present invention, there is provided a method of managing a media file comprising a plurality of media objects, the method including: correcting at least one media object from among the plurality of media objects; generating or renewing information relating to unused regions generated in the media file according to the correction; and managing the media file based on the generated or renewed information, wherein the unused regions are regions where media data for the plurality of media objects is not stored.

According to another aspect of the present invention, there is provided an apparatus for managing a media file comprising a plurality of media objects, the apparatus including: an information unit which generates or renews information relating to unused regions generated in the media file according to the correction of at least one media object from among the plurality of media objects; and a management unit which manages the media file based on the generated or renewed information, wherein the unused regions are regions where media data for the plurality of media objects is not stored.

According to another aspect of the present invention, there is provided a method of transmitting a media file comprising a plurality of media objects by a first device to a second device, the method comprising: transmitting meta data for the plurality of media objects included in the media file to the second device; determining a transmitting order of media data for the plurality of media objects based on meta data; and transmitting media data to the second device according to the determined transmitting order.

According to another aspect of the present invention, there is provided an apparatus for transmitting a media file comprising a plurality of media objects by a first device to a second device, the apparatus comprising: a meta data transmission unit which transmits meta data for the plurality of media objects included in the media file to the second device; a controller which determines a transmitting order of media data for the plurality of media objects based on meta data; and a media data transmission unit which transmits media data to the second device according to the determined transmitting order.

According to another aspect of the present invention, there is provided a method of receiving by a second device, a media file comprising a plurality of media objects transmitted by a first device, the method including: receiving meta data for the plurality of media objects from the first device: receiving media data for the plurality of media objects transmitted after a transmitting order is determined by meta data, from the first device; and arranging the received media data based on the transmitting order.

According to another aspect of the present invention, there is provided an apparatus for receiving, by a second device a media file comprising a plurality of media objects sent by a first device, the apparatus comprising: a meta data receiving unit which receives meta data for the plurality of media objects from the first device: a media data receiving unit which receives media data for the plurality of media objects transmitted from the first device after a transmitting order is determined by meta data; and an arrangement unit which arranges the received media data based on the transmitting order.

According to another aspect of the present invention, there is provided a method of managing a media file, the method comprising: extracting meta data and media data of the media file; separating the extracted meta data and media data and storing the extracted meta data and media in different locations in order to prevent location change of a region where media data is stored, according to change in size of a region where meta data is stored; and storing information relating to the locations where meta data and media data are stored in a header of the media file.

According to another aspect of the present invention, there is provided an apparatus for managing a media file, the apparatus comprising: an extraction unit which extracts meta data and media data of the media file; a separation and storing unit which separates meta data and media data and stores the meta data and media data in different locations in order to prevent location change of a region where media data is stored, according to a change in size of a region where meta data is stored; and a location storing unit which stores information relating to the locations where the meta data and media data are stored in a header of the media file.

According to another aspect of the present invention, there is provided a computer readable recording medium having embodied thereon a computer program for executing the methods described above.

### BRIEF DESCRIPTION OF THE DRAWINGS

The above and other aspects of the present invention will become more apparent by describing in detail exemplary embodiments thereof with reference to the attached drawings in which:

FIG. 1 illustrates a related art media file;

FIG. 2 is a flowchart of a method of managing a media file according to an exemplary embodiment of the present invention;

FIG. 3A illustrates generation of unused regions according to an exemplary embodiment of the present invention;

FIG. 3B illustrates information of unused regions according to an exemplary embodiment of the present invention;

FIG. 4 is a block diagram of an apparatus for managing a media file according to an exemplary embodiment of the present invention;

FIG. 5 is a flowchart of a method of moving a media file according to an exemplary embodiment of the present invention;

FIG. 6 illustrates a method of transmitting and arranging a media file according to an exemplary embodiment of the present invention;

FIG. 7A is a block diagram of an apparatus for transmitting a media file according to an exemplary embodiment of the present invention;

FIG. 7B is a block diagram of an apparatus for receiving a media file according to an exemplary embodiment of the present invention;

FIG. 8 is a flowchart of a method of managing a media file according to another exemplary embodiment of the present invention;

FIG. 9 illustrates separate storing of a media file according to an exemplary embodiment of the present invention;

FIG. 10 illustrates syntax of a media file header file according to an exemplary embodiment of the present invention; and

FIG. 11 is a block diagram of an apparatus for managing a media file according to another exemplary embodiment of the present invention;

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

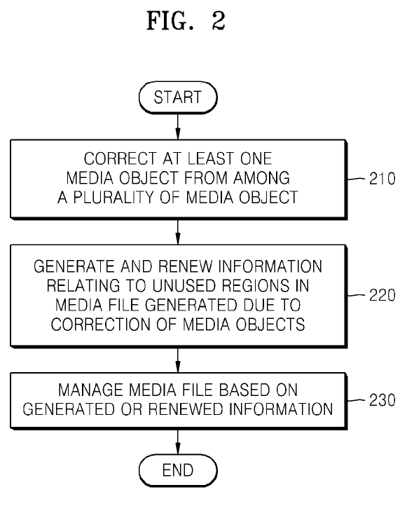

FIG. 2 is a flowchart of a method of managing a media file according to an exemplary embodiment of the present invention.

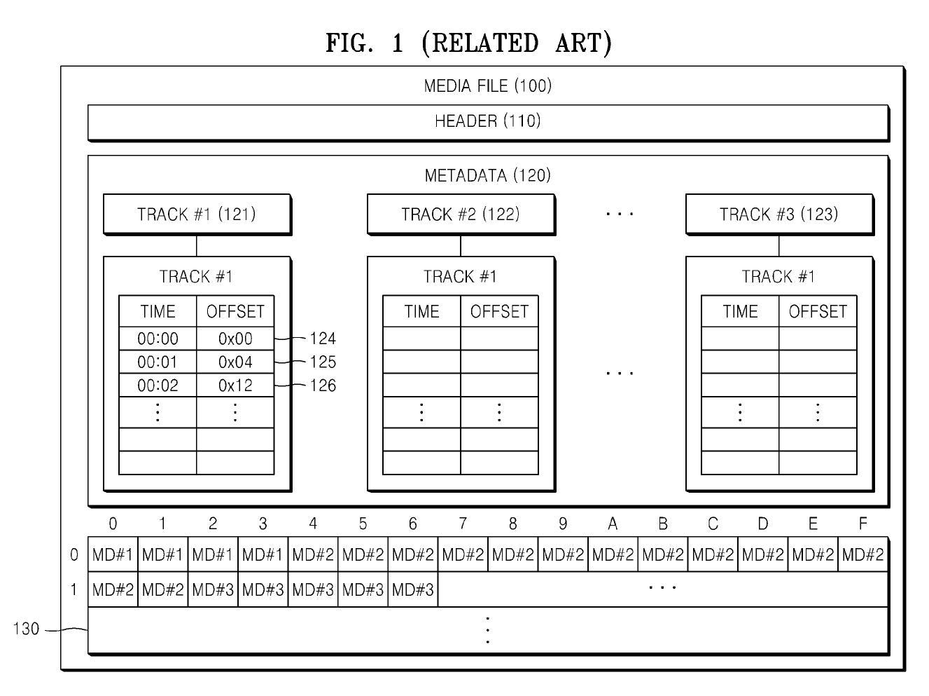

Referring to FIG. 2, an apparatus for managing a media file according to the exemplary embodiment of the present invention corrects at least one of a plurality of media objects included in the media file in operation 210. The correction of the media objects includes changing, deleting, or adding the media objects. When the media objects are deleted from the media file as described with reference to FIG. 1, unused regions are generated in the media data region 130 of the media file 100. On the contrary, when the media objects are added, information relating to the media objects is added to the meta data region 120 and media data of the added media objects is added to the media data region 130. When the media objects are simply changed, instead of deleting or adding, unused regions may be generated or media data should be added as well.

In operation 220, the apparatus for managing a media file generates or renews information relating to the unused regions in the media file generated due to the correction of the media objects in operation 210.

When the media objects are deleted, the unused regions are generated as described with reference to FIG. 1. In this case, when information relating to the unused regions is newly generated, or when information relating to the unused regions is already generated, the information is renewed. In the related art, when the unused regions are generated, media data is moved to the unused regions and meta data is renewed. According to the present invention, information relating to the unused regions is separately generated, so that the unused regions are managed based on the information relating to the unused regions.

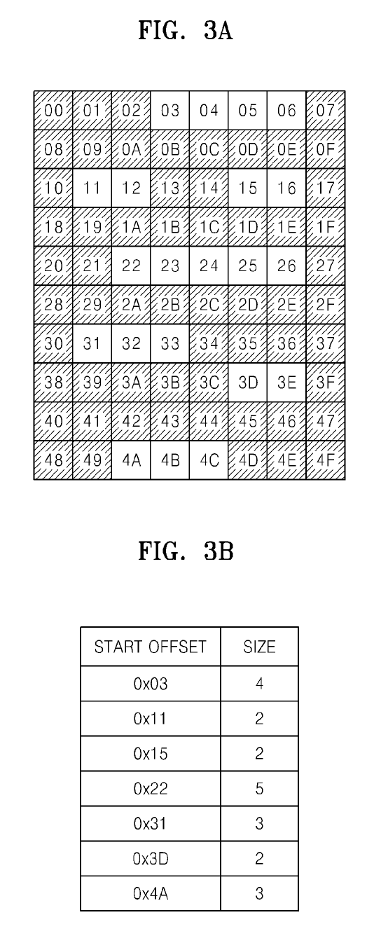

Only information on a location and a size of the unused regions generated due to deletion of the media objects is generated or renewed. Thus, a load of a system generated to move media data while filling the unused regions can be reduced. This will be described in more detail with reference to FIGS. 3A and 3B.

FIG. 3A illustrates generation of unused regions according to an exemplary embodiment of the present invention.

In FIG. 3A, the unused regions are generated in offset “0x03” through “0x06”, “0x11”, “0x12”, “0x15”, “0x16”, “0x22” through “0x26”, “0x31” through “0x33”, “0x3D”, “0x3E”, and “0x4A” through “0x4C” among the media data region 130, due to deletion of the media objects.

FIG. 3B illustrates information of unused regions according to an exemplary embodiment of the present invention.

When the unused regions are generated as in FIG. 3A, the apparatus for managing a media file generates or renews information relating to offset where the unused regions are generated and information related to the size thereof, as illustrated in FIG. 3B.

Referring back to FIG. 2, in operation 230, the apparatus for managing a media file manages the media file based on the information relating to the unused regions generated or renewed in operation 220.

When new media objects are added, media data of newly added media objects is first stored in the unused regions based on the information relating to the unused regions generated in operation 220. According to the related art, even if the unused regions are generated, information relating to the unused regions does not exist in the media file so that there were no methods to use the unused regions. Therefore, when the media objects are newly added according to the related art, added media data is added to the end part of the media data region 130 and thus a size of whole media file increases. However, according to the exemplary embodiments of the present invention, information relating to the unused regions exists in the media file and the media objects that are newly added to the unused data based on the information are first stored, so that the media objects can be added while minimizing a size of the media file.

When the media data is first stored in the unused regions, changes occur in the unused regions in the media data region 130 and thus information relating to the unused regions that is generated or renewed in operation 220 is renewed again and stored. Information relating to the unused regions is stored in the header 110 of the media file 100 or the meta data region 120.

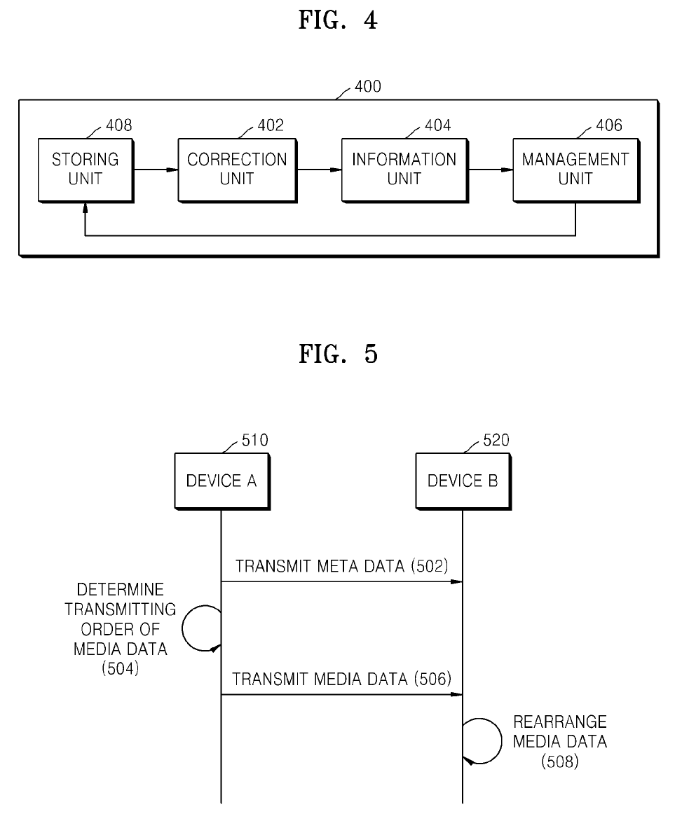

FIG. 4 is a block diagram of an apparatus for managing a media file according to an exemplary embodiment of the present invention.

Referring to FIG. 4, the apparatus 400 for managing a media file comprises a correction unit 402, an information unit 404, a management unit 406, and a storing unit 408.

The correction unit 402 corrects at least one media object of a media file stored in the storing unit 408. The media objects are corrected by changing, deleting, or adding at least one media object from among a plurality of media objects included in the media file.

The information unit 404 generates or renews information relating to unused regions, that is, regions without media data, generated in the media file as a result of correction by the correction unit 402. Information relating to location and size of the unused regions can be generated or renewed. The information relating to the unused regions that is generated or renewed is stored in the header of the media file or the meta data region and is used by the management unit 406.

The management unit 406 manages the media file based on the information relating to the unused regions generated from the information unit 404.

When the media objects are added, media data of the media objects that are first added to the unused regions based on the information relating to the unused regions generated from the information unit 404 is stored. Changes of the unused regions generated due to addition of the media data is reflected so as to renew information relating to the unused regions and renewed information is stored in the header of the media file or the meta data region.

When management of the media file is completed in the management unit 406, the media file is stored in the storing unit 408. The storing unit 408 can be any storage medium which can store the media file such as hard disks and a memory chips.

FIG. 5 is a flowchart of a method of moving a media file according to an exemplary embodiment of the present invention.

Although information relating to the unused regions is generated and the media file is managed based on the generated information, if the unused regions in the media file are left as illustrated in FIG. 3A, a media file that is larger than the media data is left and thus it is not efficient. In particular, when new media data is not added to the unused regions for a long period of time so that the unused regions continuously remain unused, the unused regions in the media file should be re-arranged. In FIG. 5, a method of re-arranging the unused regions is described with reference to moving the media file. The media file may be moved between a first storing device and a second storing device or between a server and a client via a network.

Referring to FIG. 5, in operation 502, a device A first transmits meta data of the media file to a device B. The header and meta data are first transmitted from among the header, meta data, and media data included in the media file.

In operation 504, the device A determines the transmitting order of media data to be transmitted to the device B. The transmitting order of the media data is determined based on the track (or stream) and time information included in meta data. This will be described with reference to FIG. 1.

According to an exemplary embodiment of the present invention, the device A transmits media data for the media objects 124 through 126 of a track #1, 121 to the device B according to a time order (see FIG. 1). When transmission of the track #1, 121 is completed, the device A transmits media data for the media objects of a track #2, 122 to the device B according to a time order. This process is repeatedly performed until track N so that all media data is transmitted.

According to another exemplary embodiment of the present invention, the device A first transmits media data for the media object of a first time in tracks #1 through #N (121 through 123) and then transmits media data for the media object of a second time in tracks #1 through #N (121 through 123). This process is repeatedly performed until media data for the media objects of a last time in tracks #1 through #N (121 through 123) is transmitted.

The transmitting order of media data is not particularly restricted. In addition to the processes described above, it is obvious to one of ordinary skill in the art that all transmitting orders that transmit media data of a region remaining except for the unused regions in the media data region 130 can be applied to the present invention

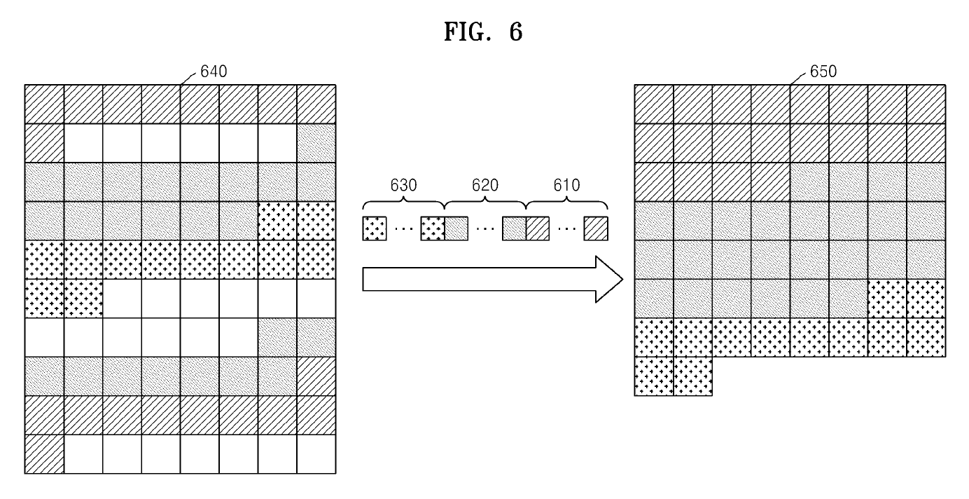

In operation 506, the device A transmits media data to the device B according to the transmitting order determined in operation 504. Only media data remaining except for the unused regions in the media data region is transmitted. According to the related art, the header, meta data, and whole media data region are regarded as one file in transmitting the media file. In this case, the unused regions of the media data region are all transmitted to the device B. However, according to the exemplary embodiments of the present invention, media data is transmitted with reference to meta data so that only regions substantially including media data, except for the unused region can be transmitted to the device B. This will be described in more detail with reference to FIG. 6.

FIG. 6 illustrates a method of transmitting and arranging a media file according to an exemplary embodiment of the present invention.

Media data 640 owned by the device A of FIG. 5 comprises media data and unused regions for three different media objects. In operation 506, the device A transmits media data remaining except for the unused regions according to the transmitting order determined in operation 504. For example, only media data 610 for a first media object is first transmitted and then media data 620 for a second media object is transmitted. Finally, media data 630 for a third media object is transmitted.

Referring back to FIG. 5, in operation 508, the device B re-arranges media data received from the device A in operation 506 based on the transmitting order determined in operation 504. As in FIG. 6, media data is classified by media objects and is then re-arranged. The media data 640 including the unused region before transmission is re-arranged as media data 650 in which the unused regions are removed after transmission.

Since media data is re-arranged, location of the media data is changed so that meta data is renewed. For example, all offsets illustrated in FIG. 1 are renewed to values after re-arrangement.

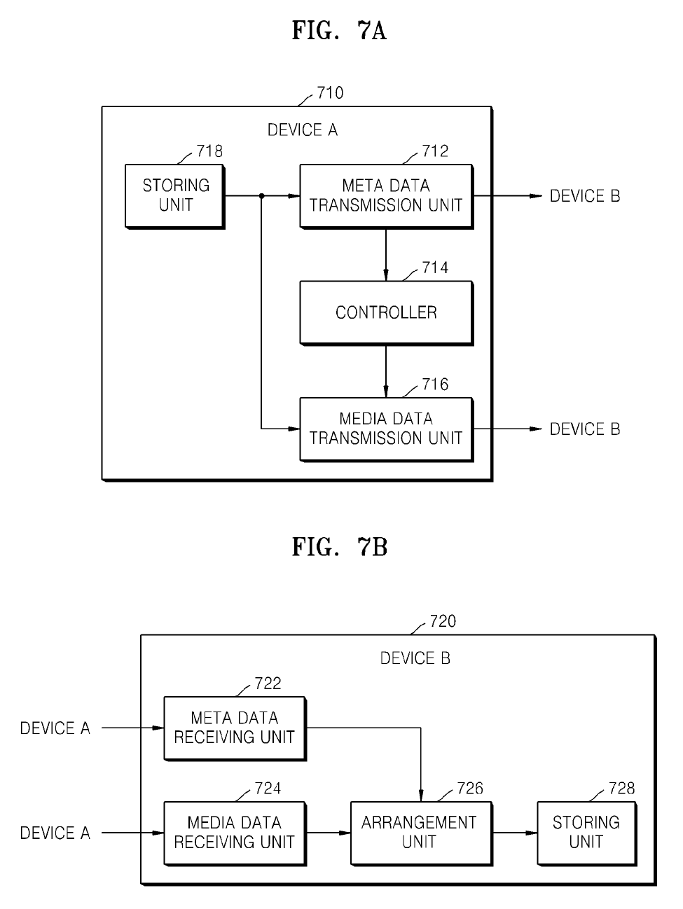

FIG. 7A is a block diagram of an apparatus for transmitting a media file according to an exemplary embodiment of the present invention.

Referring to FIG. 7A, the apparatus 710 for transmitting a media file comprises a meta data transmission unit 712, a controller 714, a media data transmission unit 716, and a storing unit 718.

The meta data transmission unit 712 transmits the header of the media file and meta data stored in the storing unit 718 to the device B. The header and meta data remaining except for the media data from among data included in the media file are transmitted to the device B.

The controller 714 determines the transmitting order of the media data based on meta data of the media file. A method of determining the transmitting order is not particularly restricted, however, as described above. The transmitting order of the media data can be determined based on track information and time information of the media objects.

The media data transmission unit 716 transmits media data to the device B according to the transmitting order determined by the controller 714. The media data included in the region remaining except for the unused region among the media data region is transmitted to the device B according to the transmitting order determined by the controller 714.

FIG. 7B is a block diagram of an apparatus for receiving a media file according to an exemplary embodiment of the present invention.

Referring to FIG. 7B, the apparatus 720 for receiving a media file comprises a meta data receiving unit 722, a media data receiving unit 724, and an arrangement unit 726, and a storing unit 728.

The meta data receiving unit 722 receives the header of the media file and meta data from the device A. The header and meta data except for media data among data included in the media file, are received.

The media data receiving unit 724 receives media data of the media file from the device A. The device A determines the transmitting order based on meta data and receives media data sequentially transmitted according to the determined transmitting order.

The arrangement unit 726 re-arranges the received media data based on the transmitting order. The media data transmitted based on track information and time information is classified by media objects and re-arranged. In addition, the arrangement unit 726 renews meta data received from the meta data receiving unit 722 based on the re-arrangement result. Since the location of media data is changed according to the re-arrangement result, meta data is renewed based on the changed location. The received header, renewed meta data, and re-arranged media data are stored in the storing unit 728.

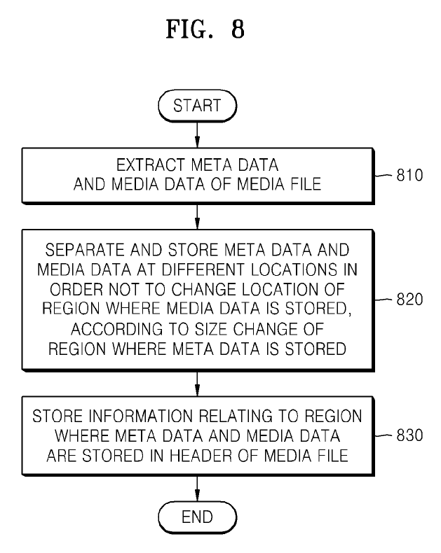

FIG. 8 is a flowchart of a method of managing a media file according to another exemplary embodiment of the present invention.

In operation 810, the apparatus for managing a media file according to the exemplary embodiment of the present invention extracts meta data and media data of the media file.

When the media file is regarded as one file and is stored in the storing device so that the header and meta data included in the media file are changed, the entire media data may be moved. The media file is continuously stored in the storing device in the order of the header, meta data, and media data. When the correction of the media objects included in the media file is accomplished, that is, when the media objects are deleted or added, the size of meta data existing between the header and media data is changed. In this case, media data continuously stored at the back of meta data before the correction of the media objects should be moved according to the changed size of meta data. According to the change in size of the meta data, the entire media data which occupies the most of the media file should be moved; however, this is inefficient.

In order to prevent this, the apparatus for managing a media file according to the exemplary embodiment of the present invention separately manages meta data and media data of the media file. In operation 810, meta data and media data are extracted from the media file for separate management of meta data and media data.

In operation 820, the apparatus for managing a media file separates and stores meta data and media data at different locations in order not to change the location of the region where media data extracted in operation 810 is stored, according to the change in size of the region where meta data is stored.

Since meta data and media data are written to a physically separated storing medium, the location of the region where media data is stored is prevented from being changed according to the change in size of the meta data. For example, meta data and media data may be stored in each different disk layer in one hard disk drive having a plurality of disks or in each different hard disk drive so that meta data and media data can be stored in the physically separated storing medium.

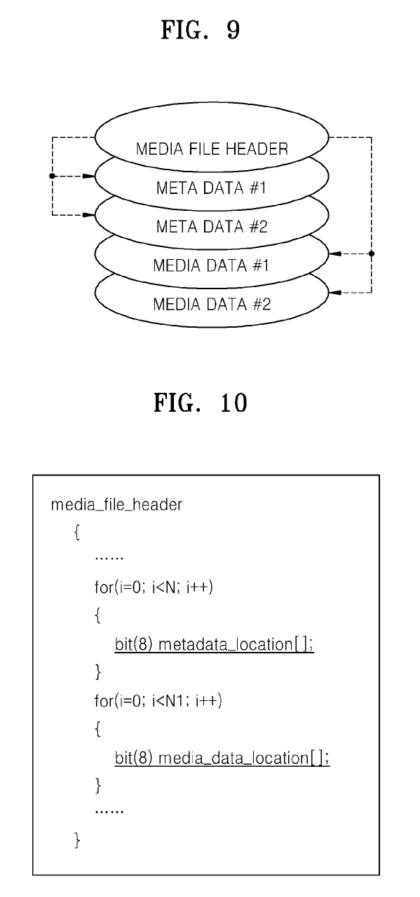

FIG. 9 illustrates separate storing of a media file according to an exemplary embodiment of the present invention.

In FIG. 9, the header, meta data, and media data of the media file are each stored in different hard disk layers. Meta data #1 is for media data #1 and meta data #2 is for media data #2.

When the media file is separated and stored in the physically separated storing medium, a file system which manages the media file should regard the header, meta data, and media data as one file to be managed. Accordingly, information on locations where meta data and media data are stored is written to the header.

FIG. 10 illustrates a syntax of a media file header file according to an exemplary embodiment of the present invention.

Referring to FIG. 10, two syntaxes are added to include information on locations where meta data and media data are stored in the header of the media file. In this case, “metadata-location[ ]” is syntax to show information on the location where meta data is stored and “media_data_location[ ]” is syntax to show information on the location where media data is stored.

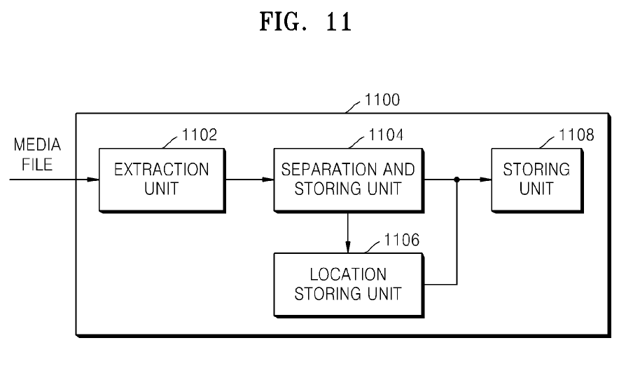

FIG. 11 is a block diagram of an apparatus for managing a media file according to another exemplary embodiment of the present invention.

Referring to FIG. 11, the apparatus for managing a media file 1100 includes an extraction unit 1102, a separation and storing unit 1104, a location storing unit 1106, and a storing unit 1108.

The extraction unit 1102 separates and extracts meta data and media data from the media file. In order to separately manage meta data and media data, meta data and media data are separated and extracted from the media file.

The separation and storing unit 1104 stores meta data and media data extracted from the extraction unit 1102 at different locations that are physically separated. In order to prevent the location of the region where media data is stored from being changed when the size of the region where meta data is stored is changed, meta data and media data are stored in different locations that are physically separated. As described above, the storing unit 1108 may be a different hard disk layer or a different hard disk drive.

The location storing unit 1106 writes information on the locations where meta data and media data are stored to the header of the media file based on the separation and storing result by the separation and storing unit 1104.

As described above with reference to FIG. 10, information on the locations where meta data and media data are stored is added to the header of the media file using newly defined syntax.

According to the exemplary embodiment of the present invention, since a plurality of the media objects included in the media file is corrected, a load generated in the apparatus for managing a media file is minimized and the media file can be efficiently managed.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer system so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of managing a media file comprising a plurality of media objects, the method comprising:
correcting at least one media object from among the plurality of media objects;
generating or renewing information relating to unused regions generated in the media file according to the correcting of the at least one media object; and
managing the media file based on the generated or renewed information,
wherein the unused regions are regions where media data for the plurality of media objects is not stored.

2. The method of claim 1, wherein the correcting of the at least one media object comprises deleting at least one media object from among the plurality of media objects.

3. The method of claim 1, wherein the managing of the media file comprises:
storing media objects that are newly added to the media file first in the unused regions based on stored information; and
generating or renewing the information relating to the unused regions based on a result of the storing of the newly added media objects.

4. The method of claim 1, wherein the information relating to the unused regions comprises a location and a size of the unused regions.

5. An apparatus for managing a media file comprising a plurality of media objects, the apparatus comprising:
an information unit which generates or renews information relating to unused regions generated in the media file according to correction of at least one media object from among the plurality of media objects; and
a management unit which manages the media file based on the generated or renewed information,
wherein the unused regions are regions where media data for the plurality of media objects is not stored.

6. The apparatus of claim 5, wherein the information unit generates or renews information relating to the unused regions generated in the media file according to deletion of at least one media object from among the plurality of media objects.

7. The apparatus of claim 5, wherein the management unit first stores media objects that are newly added to the media file in the unused regions based on stored information and generates or renews the information relating to the unused regions based on a result of the storing of the newly added media objects.

8. The apparatus of claim 5, wherein the information relating to the unused regions comprises a location and a size of the unused regions.

9. A method of transmitting by a first device to a second device, a media file comprising a plurality of media objects, the method comprising:
transmitting meta data for the plurality of media objects included in the media file to the second device;
determining a transmitting order of media data for the plurality of media objects based on the meta data; and
transmitting the media data to the second device according to the determined transmitting order.

10. The method of claim 9, wherein the determining of the transmitting order of the media data is performed according to track information and time information of the plurality of media objects included in the meta data.

11. An apparatus for transmitting by a first device to a second device, a media file comprising a plurality of media objects, the apparatus comprising:
a meta data transmission unit which transmits meta data for the plurality of media objects included in the media file to the second device;
a controller which determines a transmitting order of media data for the plurality of media objects based on the meta data; and
a media data transmission unit which transmits the media data to the second device according to the determined transmitting order.

12. The apparatus of claim 11, wherein the controller determines the transmitting order of the media data according to track information and time information of the plurality of media objects included in the meta data.

13. A method of receiving by a second device, a media file comprising a plurality of media objects transmitted by a first device, the method comprising:
receiving meta data for the plurality of media objects from the first device:
receiving media data for the plurality of media objects transmitted by the first device after a transmitting order is determined by the meta data; and
arranging, in the second device, the received media data based on the determined transmitting order.

14. An apparatus for receiving, by a second device, a media file comprising a plurality of media objects transmitted by a first device, the apparatus comprising:
a meta data receiving unit which receives meta data for the plurality of the media objects from the first device:
a media data receiving unit which receives media data for the plurality of media objects transmitted after a transmitting order is determined by the meta data, from the first device; and
an arrangement unit which arranges the received media data based on the determined transmitting order.

15. A method of managing a media file, the method comprising:
extracting meta data and media data of the media file;
separating the extracted meta data and the extracted media data and storing the extracted meta data and the extracted media in different locations in order to prevent location change of a region where media data is stored, according to a change in size of a region where the extracted meta data is stored; and
storing information relating to the different locations where the extracted meta data and the extracted media data are stored in a header of the media file.

16. The method of claim 15, wherein the separating and the storing comprises storing the extracted meta data and the extracted media data in different storing media.

17. An apparatus for managing a media file, the apparatus comprising:
an extraction unit which extracts meta data and media data of the media file;
a separation and storing unit which separates the extracted meta data and the extracted media data and stores the extracted meta data and the extracted media in different locations in order to prevent location change of a region where media data is stored, according to a change in size of a region where the extracted meta data is stored; and
a location storing unit which stores information relating to the locations where the extracted meta data and the extracted media data are stored in a header of the media file.

18. The apparatus of claim 17, wherein the separation and storing unit stores the extracted meta data and the extracted media data in different storing media.

19. A computer readable recording medium having embodied thereon a computer program for executing a method of managing a media file comprising a plurality of media objects, the method comprising:
correcting at least one media object from among the plurality of media objects;
generating or renewing information relating to unused regions generated in the media file according to the correcting of the at least one media object; and
managing the media file based on the generated or renewed information,
wherein the unused regions are regions where media data for the plurality of media objects is not stored.

20. A computer readable recording medium having embodied thereon a computer program for executing a method of transmitting by a first device to a second device, a media file comprising a plurality of media objects, the method comprising:
transmitting meta data for the plurality of media objects included in the media file to the second device;
determining a transmitting order of media data for the plurality of media objects based on the meta data; and
transmitting the media data to the second device according to the determined transmitting order.

21. A computer readable recording medium having embodied thereon a computer program for executing a method of receiving by a second device, a media file comprising a plurality of media objects transmitted by a first device, the method comprising:
receiving meta data for the plurality of media objects from the first device:
receiving media data for the plurality of media objects transmitted by the first device after a transmitting order is determined by the meta data; and
arranging, in the second device, the received media data based on the determined transmitting order.

22. A computer readable recording medium having embodied thereon a computer program for executing a method of managing a media file, the method comprising:
extracting meta data and media data of the media file;
separating the extracted meta data and the extracted media data and storing the extracted meta data and the extracted media in different locations in order to prevent location change of a region where media data is stored, according to a change in size of a region where the extracted meta data is stored; and
storing information relating to the different locations where the extracted meta data and the extracted media data are stored in a header of the media file.
